(19) United States
(12) Patent Application Publication
(10) Pub. No.: US 2009/0327622 A1
(43) Pub. Date: Dec. 31, 2009

(54) Method and Apparatus for Computer Memory Traversal

(75) Inventor: Olli Olavi Luukkainen, Salo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/165,153

(22) Filed: Jun. 30, 2008

(51) Int. Cl. G06F 12/02

(52) U.S. Cl. 711/154; 711/E12.005

(57) ABSTRACT

A method, apparatus and computer program product is provided for traversing computer memory. In one example embodiment, a method comprises determining whether a next cluster associated with a file is located in contiguous memory and obtaining a location of a next cluster from a file allocation table when the next cluster associated with the file is not located in contiguous memory. For example, the determining step may comprise reading from a cluster descriptor that is associated with the file wherein the cluster descriptor comprises an indication that a contiguous cluster in a data region is associated with the file. In one embodiment, the file allocation table is located in a first memory and the cluster descriptor is located in a second memory.

### TECHNOLOGICAL FIELD

Embodiments of the present invention generally relate to traversing computer memory, and more particularly, to a method and apparatus for efficiently traversing computer memory.

### BACKGROUND

The modem computer era has brought about significant growth in the use of portable electronic devices such as mobile phones and personal digital assistants (PDAs). These devices embed sophisticated and versatile functionality into small integrated packages. For example, devices may include memory that support mobile computer applications executing on portable electronic devices. Various types of computer memory are employed on portable electronic devices, but the memory is still limited.

### SUMMARY OF THE INVENTION

Various aspects of the invention are set out in the claims.

In accordance with an example embodiment of the present invention, a method comprises determining whether a next cluster associated with a file is located in contiguous memory and obtaining a location of a next cluster from a file allocation table when the next cluster associated with said file is not located in contiguous memory.

In accordance with another example embodiment of the present invention, another method comprises determining whether a list of cluster descriptors should be initialized and initializing the list of cluster descriptors upon determining that the list of cluster descriptors should be initialized, wherein initializing comprises indicating in each cluster descriptor in the list of cluster descriptors whether a next cluster associated with a file in a data region is located in contiguous memory.

### BRIEF DESCRIPTION OF THE DRAWINGS

For a more complete understanding of example embodiments of the present invention, reference is now made to the following description taken in connection with the accompanying drawings in which:

FIG. 1 is a block diagram depicting components of an electronic device on which features described herein may be implemented in accordance with an example embodiment of the invention;

FIG. 2A is a flow diagram illustrating a first memory comprising a file allocation table file system architecture in accordance with an example embodiment of the invention;

FIG. 2B is a flow diagram illustrating a second memory comprising a list of cluster descriptors in accordance with an example embodiment of the invention;

FIG. 3 is a flow diagram illustrating an example process for initializing a list of cluster descriptors in accordance with an example embodiment of the invention;

FIG. 4 is a flow diagram illustrating an example process for reading from a file located in a first memory organized by a file allocation table file system architecture in accordance with an example embodiment of the invention; and

FIG. 5 is a flow diagram illustrating an example process of writing to a file located in a first memory organized by a file allocation table file system architecture in accordance with an example embodiment of the invention.

### DETAILED DESCRIPTION

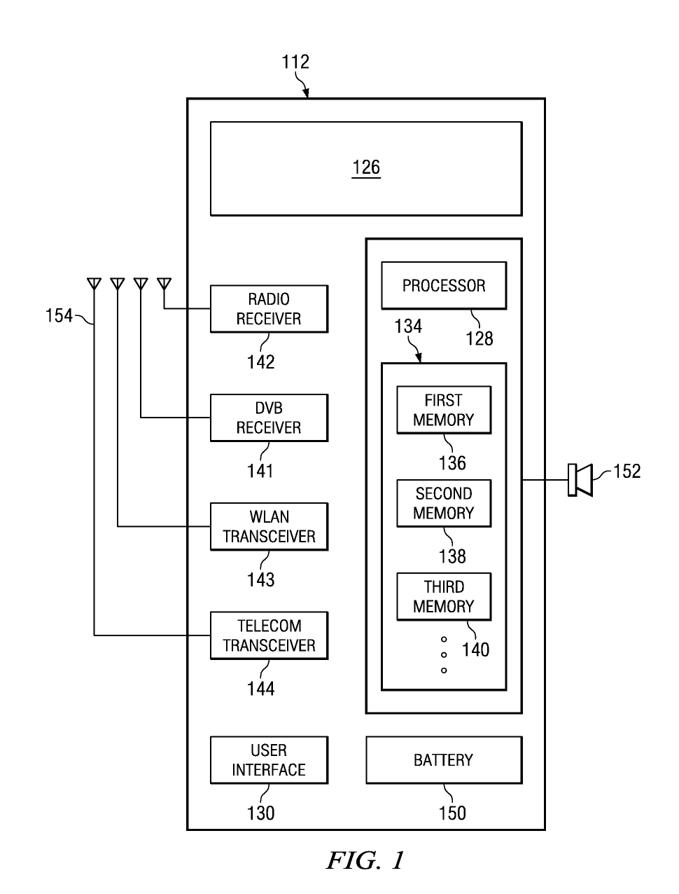

An example embodiment of the present invention and its potential advantages are best understood by referring to FIGS. 1 through 5.

FIG. 1 is a block diagram depicting components of an electronic device on which features described herein may be implemented in accordance with an example embodiment of the invention. FIG. 1 illustrates an electronic device 112, e.g., a desktop computer, laptop computer, notebook computer, network server, portable computing device, personal digital assistant, smart phone, mobile telephone, cellular telephone (cell phone), terminal, distributed computing network device, mobile media device, portable electronic device, and/or the like. In an example embodiment, the electronic device 112 may include processor 128 connected to user interface 130, memory 134 and/or the like, and display screen 126. For example, memory 134 may contain one or more memory devices, partitions or sections designated by first memory 136, second memory 138, third memory 140 and so on. In an embodiment, the electronic device 112 may also include battery 150, speaker 152 and antennas 154. User interface 130 may include a keypad, touch screen, voice interface, four arrow keys, joy-stick, stylus, data glove, mouse, roller ball, touch screen, and/or the like. In an alternative embodiment, the user interface 130 may include the entirety of or portion of display screen 126.

It should be understood that computer executable instructions and data used by processor 128 and other components within electronic device 112 may be stored in a computer readable memory 134. In an embodiment, the memory may be implemented with any combination of read only memory modules or random access memory modules, optionally including both volatile and nonvolatile memory such a diskette, CD-ROM, ROM, EEPROM, FLASH MEMORY, DVD, fixed disk, and/or the like. Software may be stored within memory 134 and/or other storage to provide instructions to processor 128 for enabling electronic device 112 to perform various functions. Alternatively, some or all of the computer executable instructions may be embodied in hardware or firmware which is not shown.

In another embodiment, electronic device 112 may include additional hardware, software and/or firmware to perform one or more aspects of the invention as described herein. For example, the electronic device 112 may include audiovisual support software/firmware. In an embodiment, the electronic device 112 may be configured to receive, decode and process digital broadband broadcast transmissions that are based, for example, on the Digital Video Broadcast (DVB) standard, such as DVB-H, DVB-T or DVB-MPH, through a specific DVB receiver 141. Further, digital Audio Broadcasting/Digital Multimedia Broadcasting (DAB/DMB) may also be used to convey television, video, radio, and data.

In an alternative embodiment, the electronic device 112 may also include other types of receivers for digital broadband broadcast transmissions. Further, the electronic device 112 may be configured to receive, decode and process transmissions through radio receiver 142, WLAN transceiver 143, and telecommunications transceiver 144. In some embodiments, electronic device 112 may receive radio data stream (RDS) messages.

In an embodiment, the electronic device 112 may use computer program product implementations including a series of computer instructions fixed either on a tangible medium, such as a computer readable storage medium, a diskette, CD-ROM, ROM, EEPROM, FLASH Memory, DVD, fixed disk or transmittable to electronic device 112, via a modem or other interface device, such as a communications adapter connected to a network over a medium, which is either tangible, for example, optical or analog communication lines or implemented wirelessly, for example, microwave, infrared, radio, or other transmission techniques. The series of computer instructions may embody all or part of the functionality with respect to the computer system, and may be written in a number of programming languages for use with many different computer architectures and/or operating systems, as would be readily appreciated by one of ordinary skill. The computer instructions may be stored in any memory device, for example, memory 134, such as a semiconductor, magnetic, optical, or other memory device, and may be transmitted using any communications technology, such as optical infrared, microwave, or other transmission technology. Such a computer program product may be distributed as a removable storage medium with accompanying printed or electronic documentation, such as shrink wrapped software, preloaded with a computer system, for example, on system ROM or fixed disk, or distributed from a server or electronic bulletin board over a network such as the Internet or World Wide Web. Various embodiments of the invention may also be implemented as hardware, firmware or any combination of software such as a computer program product, computer-readable medium, hardware and firmware. Moreover, the functionality as depicted may be located on a single physical computing entity, or may be divided between multiple computing entities.

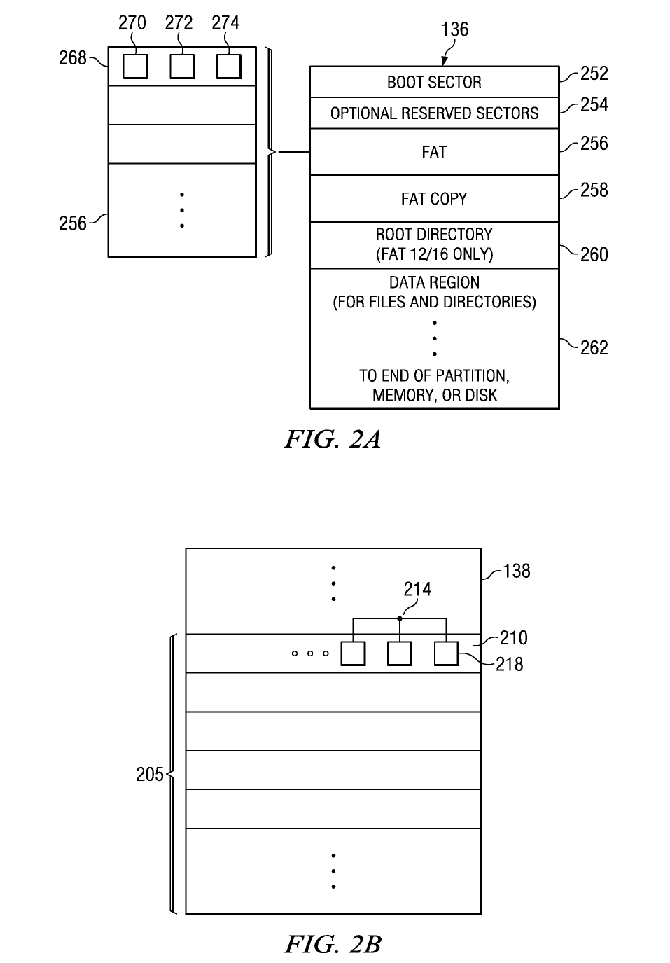

FIG. 2A is a flow diagram illustrating a first memory comprising a file allocation table file system architecture in accordance with an example embodiment of the invention. In this example embodiment, the FAT file system architecture may include any implementation including standard, proprietary or de facto implementations such as original FAT, FAT12, FAT16, FAT32, FAT64 or exFAT from Microsoft Corporation. For example, a FAT file system architecture may include boot sector 252, optional reserved sectors 254, FAT 256, FAT copy 258, root directory 260, and data region 262. In an embodiment, FAT 256 includes a list of FAT entries 256. Each FAT entry 268 may include next cluster indication 270, free cluster indication 272 and last cluster in file indication 274 as well as other indications. In an embodiment, a file may include any type of formatted or unformatted data including file directory data.

FIG. 2B is a flow diagram illustrating a second memory 138 comprising a list of cluster descriptors in accordance with an example embodiment of the invention. Each cluster descriptor 210 in second memory 138 may map to each FAT entry 268 in FAT 256. In an embodiment, each cluster descriptor 210 in second memory 138 may comprise a set of one of more cluster attributes 214. For example, each cluster descriptor 210 may comprise next cluster in same file indication 218 that indicates whether the next contiguous cluster in data region 262 of first memory 136 is associated with the same file as a reference cluster in data region 262. In an embodiment, if each cluster descriptor comprises a single attribute such as next cluster in same file indication 218, then each cluster descriptor 210 may be represented by a single bit within a byte containing eight bitmapped cluster descriptors 210. In an alternate embodiment, list of cluster descriptors 210 may be located in first memory 136 such as while the file system is unmounted or during runtime.

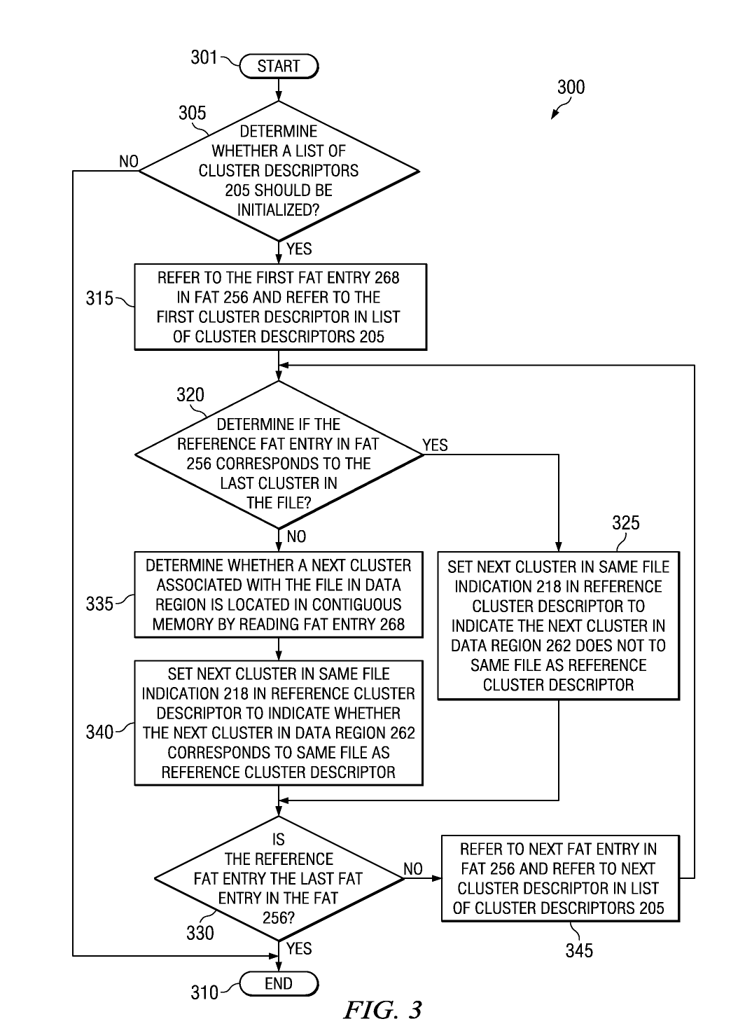

FIG. 3 is a flow diagram illustrating an example process for initializing a list of cluster descriptors in accordance with an example embodiment of the invention. FIG. 3 illustrates an example process 300 showing the initialization of a list of cluster descriptors, such as the list of cluster descriptors 205 in FIG. 2, in accordance with an example embodiment of the invention. Example process 300 may be performed using an electronic device such as electronic device 112 in FIG. 1. The process begins at 301 and continues to 305. In 305, a determination is made whether a list of cluster descriptors should be initialized. A list of cluster descriptors may be initialized when an electronic device is powered on or while a first memory such as first memory 136 of FIG. 1 is replaced. A list of cluster descriptors may also be initialized at other appropriate times. In an embodiment, initializing a list of cluster descriptors comprises indicating in each cluster descriptor in the list of cluster descriptors whether a next cluster associated with a file in a data region is located in contiguous memory. If it is determined that a list of cluster descriptors should not be initialized, the method terminates at 310. Otherwise, 315 is performed.

In 315, a reference is made to the first FAT entry 268 in FAT 256. Another reference is made to the first cluster descriptor in list of cluster descriptors 205. In 320, if the reference FAT entry in FAT 256 refers to the last cluster in the file, then 325 is performed. Otherwise, 335 is performed.

In one embodiment, a determination may be made whether the reference FAT entry in a FAT corresponds to the last cluster in the file by examining the size of the file. In an alternative embodiment, a determination may be made by other techniques, for example, by examining a last cluster in a file indication, such as file indication 274 of FIG. 2, in reference FAT entry.

In 325, next cluster in same file indication 218 of FIG. 2 is set in the reference cluster descriptor to indicate that the next contiguous cluster in data region 262 is not part of the same file as the cluster in data region 262 corresponding to the reference cluster descriptor. Execution proceeds to 330.

In 330, if the reference FAT entry is the last FAT entry in the FAT, then the method terminates at 310, otherwise 345 is performed.

In 345, a reference is made to the next FAT entry in FAT 256 of FIG. 2 and a reference is also made to the next cluster descriptor in list of cluster descriptors 205 of FIG. 2. Execution then proceeds to 320.

In 320, if the reference FAT entry in the FAT does not correspond to the last cluster in the file then 335 is performed.

In 335, a determination is made whether the next cluster associated with the file in data region 262 of FIG. 2 is located in contiguous memory. In one embodiment, this determination may be made by reading a FAT entry in a FAT. Execution then proceeds to 340.

In 340, next cluster in same file indication 218 is set to indicate whether the next cluster in data region 262 corresponds to same file as the reference cluster descriptor. Execution then proceeds to 330.

In 330, if the reference FAT entry is the last FAT entry in FAT then execution is terminated at 310, otherwise 345 is performed.

In one embodiment of example process 300, the FAT may be located in a first memory such as first memory 136 of FIG. 1 and the cluster descriptors may be located in a second memory such as second memory 138 of FIG. 1. In an alternate embodiment, the FAT and the cluster descriptors may be located in a first memory.

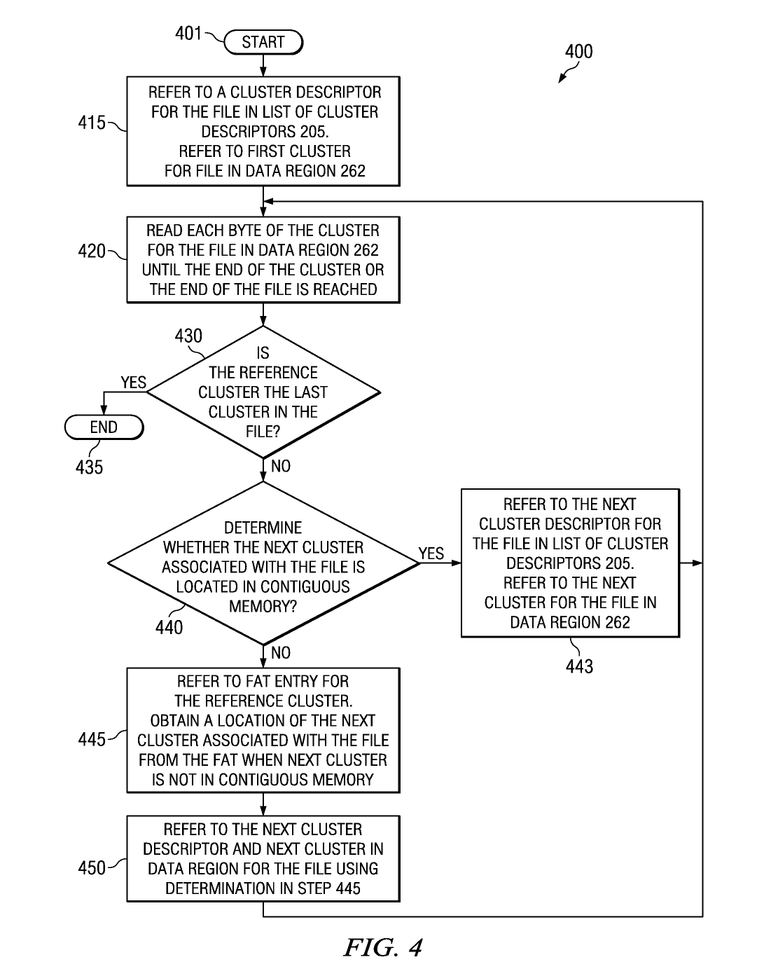

FIG. 4 is a flow diagram illustrating an example process for reading from a file located in a first memory organized by a file allocation table file system architecture in accordance with an example embodiment of the invention. Example process 400 may be performed using an electronic device such as electronic device 112 in FIG. 1. FIG. 4 uses a previously initialized list of cluster descriptors 205 of FIG. 2 located in a second memory such as the second memory 138 of FIG. 1. In one embodiment, reading may include seeking specific data from a file. The method begins at 410 and continues to 415.

In 415, a reference is made to a cluster descriptor for the file in the list of cluster descriptors 205 shown in FIG. 2. The reference may be made to the first cluster descriptor for the file or any one of the cluster descriptors for the file including the last cluster descriptor for the file. Another reference is made to the first cluster for the file in data region 262 of FIG. 2. The reference may be made to the first cluster for the file or any one of the clusters for the file including the last cluster for the file.

In 420, each byte of the cluster in data region 262 of FIG. 2 is read until the end of the cluster or until the end of the file is reached.

In 430, if the reference cluster in data region 262 is the last cluster in the file, then the execution terminates at 435, otherwise it is performed.

In 440, a determination is made whether next cluster associated with the file is located in contiguous memory. If the next contiguous cluster in data region 262 is associated with the file, then 443 is performed, otherwise it 445 is performed. In an example embodiment, the determination whether the next cluster associated with the file is located in contiguous memory comprises reading from a cluster descriptor wherein the cluster descriptor is associated with the file. The cluster descriptor comprises an indication that a contiguous cluster in a data region is associated with the file.

In 445, a reference is made to the FAT entry for the reference cluster. Obtain a location of the next cluster from a file allocation table when the next cluster associated with the file is not located in contiguous memory.

In 450, a reference is made to the next cluster descriptor in the list of cluster descriptors. Another reference is made to the next cluster for the file in the data region using determination in 445. Execution then proceeds to 420.

In one embodiment of example process 400, the FAT is located in a first memory such as first memory 136 of FIG. 1 and the cluster descriptors are located in a second memory such as second memory 138 of FIG. 1. In an alternate embodiment, the FAT and the cluster descriptors are located in a first memory. The first memory may be a volatile memory or a non-volatile memory. The second memory may be a volatile memory or a non-volatile memory. The non-volatile memory may be at least one of the following: a FLASH memory, a compact disk read-only memory, a read-only memory, an electrically erasable programmable read-only memory, a digital video disk, or a fixed disk. The volatile memory may be a random access memory.

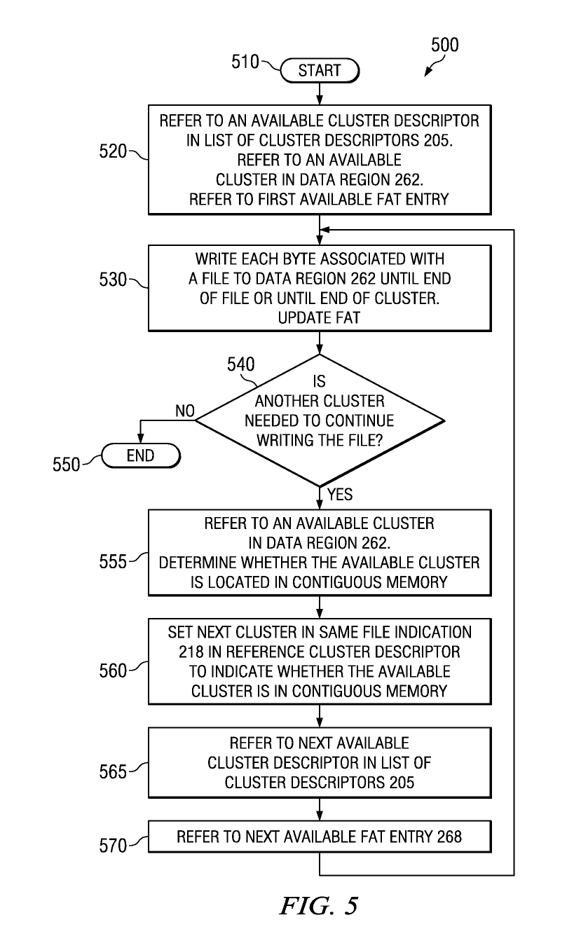

FIG. 5 is a flow diagram illustrating an example process of writing to a file located in a first memory organized by a file allocation table file system architecture in accordance with an example embodiment of the invention. Example process 500 may be performed using an electronic device such as electronic device 112 in FIG. 1. The method begins at 510 and continues to 520. In 520, a first reference is made to an available cluster descriptor in the list of cluster descriptors 205 of FIG. 2. A second reference is made to an available cluster in data region 262 of FIG. 2. A third reference is made to an available FAT entry.

In 530, each byte associated with a file is written to data region 262 until the end of the file or until the end of the cluster is reached. Also, one or more appropriate fields in the referenced FAT entry may be updated at this point to reflect the data written to the data region. One skilled in art will recognized which fields in the FAT entry may be written at this point based the implemented version of FAT system architecture.

In 540, if the file is large enough such that another available cluster is needed to continue writing the file, then 555 is performed, otherwise execution terminates at 550. Consideration may be given at this point to setting the next cluster in the same file indication in the reference cluster descriptor, however, this is not required in the last cluster descriptor of each file.

In 555, a reference is made to an available cluster in the data region and a determination is made whether the available cluster is located in contiguous memory. In 560, an indication is made in a cluster descriptor whether the available cluster associated with the file is located in contiguous memory. In one embodiment, the indication may be made by setting next cluster in same file indication 218 of FIG. 2 in the reference cluster descriptor. Execution proceeds to 565. In 565, a reference is made to the next available cluster descriptor in the list of cluster descriptors. Execution then proceeds to 570. In 570, a reference is made to the next available FAT entry. Execution proceeds then to 530.

In one embodiment of example process 500, the FAT is located in a first memory such as first memory 136 of FIG. 1 and the cluster descriptors are located in a second memory such as second memory 138 of FIG. 1. In an alternate embodiment, the FAT and the cluster descriptors are located in a first memory. The first memory may be a volatile memory or a non-volatile memory. The second memory may be a volatile memory or a non-volatile memory. The non-volatile memory may be at least one of the following: a FLASH memory, a compact disk read-only memory, a read-only memory, an electrically erasable programmable read-only memory, a digital video disk, or a fixed disk. The volatile memory may be a random access memory.

Without in any way limiting the scope, interpretation, or application of the claims appearing below, it is possible that a technical effect of one or more exemplary embodiments, discussed herein, may be to allow efficient traversal of computer memory when a FAT computer file system architecture is utilized. By utilizing one or more embodiments herein, it is possible to minimize reading from and writing to some memory devices that may be subject to wear when the number of read or write accesses to a device exceeds certain thresholds. In one embodiment, by utilizing a list of cluster descriptors located in a memory device which may be susceptible to less wear, memory accesses may be minimized in another memory device which may be susceptible to more wear. For example, when clusters in a data region are contiguous, accesses to a memory device susceptible to more wear comprising a FAT may be minimized by referring to list of cluster descriptors stored on a memory device susceptible to less wear during memory traversal. By referring to a list of cluster descriptors, a determination may be made whether a next cluster in a data region associated with a file is located contiguously thereby eliminating a need to determine the location of a next cluster from a FAT.

The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
determining whether a next cluster associated with a file is located in contiguous memory; and
obtaining a location of said next cluster from a file allocation table when said next cluster associated with said file is not located in contiguous memory.

2. The method of claim 1, wherein determining further comprises reading from a cluster descriptor and wherein said cluster descriptor is associated with said file.

3. The method of claim 2, wherein said cluster descriptor comprises an indication that a contiguous cluster in a data region is associated with said file.

4. The method of claim 3, wherein said file allocation table is located in a first memory and said cluster descriptor is located in a second memory.

5. The method of claim 3, wherein said file allocation table and said cluster descriptor are located in a first memory.

6. The method of claim 4, wherein said first memory is a non-volatile memory and said second memory is a volatile memory.

7. The method of claim 6, wherein said non-volatile memory is at least one of the following: a FLASH memory, a compact disk read-only memory, a read-only memory, an electrically erasable programmable read-only memory, a digital video disk, or a fixed disk.

8. The method of claim 6, wherein said volatile memory is a random access memory.

9. The method of claim 4, further comprising:
reading each byte of a data associated with said file from said data region until either end of said cluster or end of said file is reached, wherein said data region is located in said first memory.

10. A method comprising:
writing each byte associated with a file to a data region until end of said cluster or end of said file is reached;
referring to an available cluster in said data region;
determining whether said available cluster is located in contiguous memory; and
indicating in a cluster descriptor whether said available cluster associated with said file is located in contiguous memory.

11. The method of claim 10, wherein said data region is located in a first memory and said cluster descriptor is located in a second memory.

12. The method of claim 11, wherein said first memory is a non-volatile memory and said second memory is a volatile memory.

13. The method of claim 11, wherein referring further comprises locating said available cluster from a file allocation table located in a second memory.

14. A method comprising:
determining whether a list of cluster descriptors is to be initialized; and
initializing said list of cluster descriptors,
wherein initializing comprises indicating in each cluster descriptor in said list of cluster descriptors whether a next cluster associated with a file in a data region is located in contiguous memory.

15. The method of claim 14, wherein initializing further comprises determining whether a next cluster associated with said file in said data region is located in said contiguous memory by reading an associated file allocation table entry in a file allocation table.

16. The method of claim 14, wherein said data region is located in a first memory and said list of cluster descriptors is located in a second memory.

17. An apparatus, comprising:
a processor configured to:
determine whether a next cluster associated with a file is located in contiguous memory; and
obtain a location of a next cluster from said file allocation table when said next cluster associated with said file is not located in contiguous memory.

18. The apparatus of claim 17, wherein said processor is further configured to
read from a cluster descriptor,
wherein said cluster descriptor is associated with said file, and
wherein said cluster descriptor comprises an indication that a contiguous cluster in a data region is associated with said file.

19. The apparatus of claim 18, wherein said file allocation table is located in a first memory and said cluster descriptor is located in a second memory.

20. The apparatus of claim 18, wherein said file allocation table and said cluster descriptor are located in a first memory.

21. The apparatus of claim 19, wherein said first memory is a non-volatile memory and said second memory is a volatile memory.

22. The apparatus of claim 21, wherein said non-volatile memory is at least one of the following: a FLASH memory, a compact disk read-only memory, a read-only memory, an electrically erasable programmable read-only memory, a digital video disk or a fixed disk.

23. The apparatus of claim 21, wherein said volatile memory is a random access memory.

24. The apparatus of claim 19, further comprising:
said processor further configured to read each byte of a reference cluster associated with said file from said data region until either end of said cluster or end of said file is reached, wherein said data region is located in said first memory.

25. An apparatus comprising,
a processor configured to:
determine whether a list of cluster descriptors should be initialized; and
initialize said list of cluster descriptors upon determining that said list of cluster descriptors should be initialized, wherein initializing comprises indicating in each cluster descriptor in said list of cluster descriptors whether a next cluster associated with a file in a data region is located in contiguous memory.

26. The apparatus of claim 25, further comprising:
said processor further configured to determine whether a corresponding next cluster associated with said file in said data region is located in said contiguous memory by reading an associated file allocation table entry in a file allocation table.

27. The apparatus of claim 26, wherein said data region is located in a first memory and said list of cluster descriptors is located in a second memory.

28. A computer program product comprising a computer-readable medium bearing computer program code embodied therein for use with a computer, the computer program code comprising:
code for determining whether a next cluster associated with a file is located in contiguous memory; and
code for obtaining a location of a next cluster from said file allocation table when said next cluster associated with said file is not located in contiguous memory.

29. The computer program product of claim 28, wherein determining comprises reading from a cluster descriptor and said cluster descriptor is associated with said file.

30. The computer program product of claim 29, wherein said cluster descriptor comprises an indication that a contiguous cluster in a data region is associated with said file.

31. The computer program product of claim 30, wherein said file allocation table is located in a first memory and said cluster descriptor is located in a second memory.

32. The computer program product of claim 31, wherein said first memory is a non-volatile memory and said second memory is a volatile memory.

33. The computer program product of claim 32, wherein said non-volatile memory is at least one of the following: a FLASH memory, a compact disk read-only memory, a read-only memory, an electrically erasable programmable read-only memory, a digital video disk or a fixed disk.

34. The computer program product of claim 32, wherein said volatile memory is a RAM.

35. The computer program product of claim 32, further comprising:
a third executable portion for reading each byte of a reference cluster associated with said file from said data region until end of said cluster is reached or end of said file is reached, wherein said data region is located in said first memory.

36. A computer-readable medium encoded with instructions that, when executed by a computer, perform:
determining whether a next cluster associated with a file is located in contiguous memory; and
obtaining a location of said next cluster from a file allocation table when said next cluster associated with said file is not located in contiguous memory.

37. The method of claim 36, wherein determining comprises reading from a cluster descriptor and wherein said cluster descriptor is associated with said file.

38. The method of claim 37, wherein said cluster descriptor comprises an indication that a contiguous cluster in a data region is associated with said file.

39. The method of claim 37, wherein said file allocation table is located in a first memory and said cluster descriptor is located in a second memory.

40. The method of claim 39, wherein said first memory is a non-volatile memory and said second memory is a volatile memory.

41. The method of claim 40, wherein said non-volatile memory is at least one of the following: a FLASH memory, a compact disk read-only memory, a read-only memory, an electrically erasable programmable read-only memory, a digital video disk or a fixed disk.

42. The method of claim 40, wherein said volatile memory is a random access memory.
